(19) United States
(12) Patent Application Publication
(10) Pub. No.: US 2021/0241208 A1
(43) Pub. Date: Aug. 5, 2021

(54) METHOD AND SYSTEM FOR IDENTIFYING AND ONBOARDING A VEHICLE INTO INVENTORY

(71) Applicant: Capital One Services, LLC, McLean, VA (US)

(72) Inventors: Qiaochu TANG, Frisco, TX (US); Micah PRICE, The Colony, TX (US); Avid GHAMSARI, Frisco, TX (US); Jason HOOVER, Grapevine, TX (US); Geoffrey DAGLEY, McKinney, TX (US)

(73) Assignee: Capital One Services, LLC, McLean, VA (US)

(21) Appl. No.: 16/778,023

(22) Filed: Jan. 31, 2020

(51) Int. Cl. G06Q 10/08; G06Q 30/00; G06F 16/953; G06N 20/00; G06T 7/73; G06F 16/532

(52) U.S. Cl. CPC G06Q 10/087; G06Q 30/0185; G06F 16/953; G06T 2207/30248; G06T 7/73; G06F 16/532; G06N 20/00

(57) ABSTRACT

The disclosed embodiments provide methods and systems for identifying and onboarding a vehicle into an inventory. According to one exemplary embodiment, an image is captured of a vehicle. Based on the captured image, attributes of the imaged vehicle are determined. A vehicle onboarding system storing a plurality of vehicle attributes is queried, the query being based on the imaged vehicle, and a matching vehicle from the vehicle onboarding system based on the query is received. The mobile device further transmits the image of the vehicle to a vehicle inventory system with instructions to associate the image with the vehicle attributes of the matching vehicle in the vehicle inventory system. Image analysis is employed to determine vehicle attributes.

### TECHNICAL FIELD

The disclosed embodiments generally relate to using vehicle identification technologies to identify attributes of a vehicle. More particularly, the disclosed embodiments relate to using vehicle identification technologies to extract features and attributes of a vehicle and onboard a vehicle into an inventory.

### BACKGROUND

Auto dealerships often purchase, either from auto manufacturers, auction platforms, or previous vehicle owners, a large number of vehicles for subsequent sales. To manage these vehicles, dealerships may have multiple internal systems. These may include systems for receiving vehicle information for vehicles initially brought into the dealership for a trade-in evaluation. These also include those used to maintain a current inventory of the dealership's vehicles listed for sale. Before being accepted into a dealership's inventory, it is common for vehicle data to be gathered from the vehicle in an onboarding system during the initial trade-in transaction. After the vehicle is accepted by the dealership as a trade-in, the vehicle may then be cleaned and/or reconditioned, and added to the dealership's inventory system and listed for sale. This process may require matching information between systems before creating a vehicle listing for sale of the vehicle.

Due to the number of vehicles handled by most dealerships, the onboarding process may require a significant amount of time and resources to process each vehicle, locate data across different systems, add vehicle images and attributes to the inventory system, and create corresponding vehicle listings for sale. An improved onboarding process and system is desired, including one that can utilize image data to determine vehicle attributes and use those attributes to match data in other systems. An improved system is also desired to address errors in stored vehicle data with minimal user input, and to optionally identify a condition and possible value of a trade-in vehicle using image analysis. To address these and other obstacles in this process, an improved method of onboarding vehicles is provided.

### SUMMARY

In the following description, certain aspects and embodiments of the present disclosure will become evident. It should be understood that the disclosure, in its broadest sense, could be practiced without having one or more features of these aspects and embodiments.

The disclosed embodiments include methods, devices and systems for onboarding an item into an inventory by extracting attributes of the item using identification technologies. According to some embodiments, one exemplary system can include a mobile device having at least one processor, and at least one non-transitory computer-readable medium storing instructions. When executed, the instructions can cause the at least one processor to perform operations including capturing of an image of a vehicle and determining attributes of the imaged vehicle based on the captured image. The operations can further include querying a vehicle onboarding system storing a plurality of vehicle attributes based on the imaged vehicle. The operations can further include receiving a matching vehicle from the vehicle onboarding system based on the query. The operations can further include transmitting the image of the vehicle to a vehicle inventory system with instructions to associate the image with the vehicle attributes of the matching vehicle in the vehicle inventory system.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 depicts a schematic of an exemplary system for identifying and onboarding a vehicle into an inventory, consistent with disclosed embodiments.

FIG. 2 depicts a block diagram of an exemplary mobile device, consistent with disclosed embodiments.

FIG. 3 depicts a block diagram of an exemplary computing device, consistent with disclosed embodiments.

FIG. 4 depicts an exemplary interaction diagram for a method of identifying and onboarding a vehicle into an inventory, consistent with disclosed embodiments.

FIG. 5 depicts a flowchart of an exemplary process for identifying and onboarding a vehicle to an inventory, consistent with disclosed embodiments.

### DESCRIPTION OF THE EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts.

An auto dealership may bring in a large number of vehicles for display and sale. The vehicles can come from various sources, such as through purchase from auto manufacturers, vehicle auctions, or previous vehicle owners. Many users, when purchasing a new vehicle, bring in their old vehicles to the dealership for trade-in. The vehicles brought into the dealership may then go through an onboarding process so that the vehicles can be added to the inventory and/or posted on a listing platform. The onboarding process, as used herein, includes the process of evaluating vehicles, collecting vehicle information and images, and adding the vehicle into an inventory system for vehicle listing creation and publishing.

As an example, trade-in vehicles brought by users may be of various types and conditions. During the trade-in process, the dealership staff may collect basic information about the vehicle, such as information regarding one or more of make, model, year, trim level, body style, door count, exterior color, engine type, transmission type, mileage, etc. Such information may be collected and input into an onboarding system associated with the dealership. The onboarding system, as used herein, can include a system (such as one or more servers) associated with the dealership for managing and processing vehicles brought into the dealership. The onboarding system may further be associated with or include one or more databases storing entries of various vehicles. In addition to collecting basic vehicle information and entering the information into the onboarding system, the dealership staff can further inspect and evaluate the vehicle, such as check historical damage, usage or repairs of the vehicle, evaluate exterior and interior conditions of the vehicle, etc. The inspection can assist in determining the current value of the vehicle for pricing purposes and assist in determining the necessity of cleaning and reconditioning. Information collected during the inspection process is then added to a corresponding vehicle entry in the onboarding system. The onboarding system maintains this information for use by the dealership in determining a trade-in value prior to the dealership taking ownership of the vehicle.

Generally, dealerships maintain a separate inventory system. The inventory system can serve as a platform for managing vehicles in the inventory of the dealership, which include vehicles that are available and/or ready for sale. The inventory system can further generate and publish a vehicle listing based on the information entered therein by dealership staff.

Before a vehicle can be added to the inventory system and listed, the dealership staff may obtain images of the vehicle, which can be included in the vehicle listing. Vehicle images, if included in the listings, can assist potential buyers to assess vehicle features and conditions by allowing the buyers to view the vehicle online. In this manner, actual images of the vehicle can help a user efficiently narrow her search and make a purchase decision. Vehicle listings that do not include vehicle images, or those that include inaccurate images, may reflect negatively on the vehicle and the dealership. Furthermore, an incomplete or inaccurate listing may cause a potential buyer to visit a dealership to inspect an undesired vehicle, wasting the time and attention of the buyer. The buyer may not purchase the vehicle and may develop a negative impression of the dealership, the independent web platform used to view the vehicle listing, or the downloadable application which the users use for their vehicle search. Apart from the resulting reduction in sales and negative impression, dealerships may be further harmed when users cannot locate vehicles that do match their requirements. In addition, users are more likely to visit the dealership if the online listings are accurate and include actual images of the listed vehicles.

Although users and dealerships may benefit from listings including images of the listed vehicles, providing such images in the onboarding process require a significant amount of time and resources. A dealership may have thousands of new and used vehicles to be onboarded. Obtaining images for each vehicle and matching vehicle data, including images, between an onboarding system and an inventory system becomes nearly infeasible.

The disclosed embodiments address the above problems by collecting and processing vehicle images and associating these images with corresponding vehicle information for onboarding a vehicle into an inventory. In some embodiments, the images can be collected by a vehicle identification application operating on a mobile device of a user, such as a staff member of a dealership. For example, a user can image the vehicle using the mobile device. The vehicle identification application can determine attributes of the vehicle based on the image (which can be a still image or a frame of a video feed). The determined attributes can include one or more attributes associated with and useable to identify a particular vehicle, including a vehicle identification number (VIN), make, model, year, trim level, body style, door count, exterior color, vehicle condition, etc. Based on the determined attributes, the mobile device can query a vehicle onboarding system storing entries of a plurality of vehicles for a matching vehicle.

After receiving a query request from the mobile device, the onboarding system can conduct a search based on the attributes received from the mobile device and identify a matching vehicle entry with attributes consistent with the received attributes. The onboarding system may then return the matching vehicle entry to the mobile device, along with information of the matching vehicle.

The matching vehicle entry can then be displayed on a display of the mobile device. The mobile device may receive user input confirming the matching vehicle is the same as the imaged vehicle. The mobile device can then transmit the image to an inventory system associated with the dealership, instructing the inventory system to associate the image with the corresponding vehicle attributes. The image and vehicle attributes can further be used to generate a vehicle listing by, for example, a third-party application programming interface (API) associated with the inventory system. In some embodiments, the generated vehicle listings can be displayed on a web page associated with the dealership or stored in an internal system associated with the dealership. Further, the listings can further be shared with and published on a web platform or downloadable application, such as the CAPITAL ONE® AUTO NAVIGATOR® platform, or the like.

Consistent with disclosed embodiments, a user can use a mobile device to take images of a vehicle to be onboarded to an inventory. The mobile device may identify attributes of the imaged vehicle and obtain a matching vehicle from an onboarding system. The image can then be associated with attributes of the vehicle, so that the vehicle can be efficiently loaded into an inventory system for listing generation and publishing. Potential buyers can benefit from the accurate representation of the vehicle based on the actual image(s) included in the listing. Dealerships can benefit from an efficient onboarding process, without the need of devoting a significant amount of resources for processing vehicle images and matching vehicle data across disparate systems. While the above is disclosed in connection with a mobile device, it is of course understood and recognized that other computing devices may be utilized to achieve the disclosed features. These may include desktop or mobile computing devices, including those with internal imaging devices or those in communication with external imaging devices. As disclosed further below, various embodiments are contemplated.

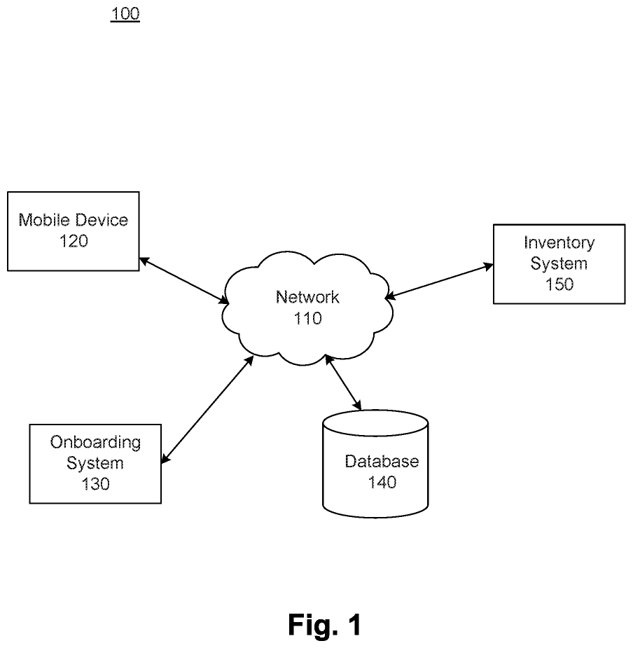

To further illustrate the technical solutions disclosed herein and the advantages thereof, exemplary embodiments are described below with reference to the accompanying drawings. FIG. 1 depicts a schematic of an exemplary system 100 for identifying and onboarding a vehicle into an inventory, consistent with disclosed embodiments. As shown in FIG. 1, system 100 may include network 110, at least one mobile device 120, onboarding system 130, database 140, and inventory system 150. These components may communicate with each other, directly or indirectly, or with other systems, using network 110. Mobile device 120 may be configured to capture an image of a vehicle, identify attributes of the vehicle, and obtain a matching vehicle from onboarding system 130 (associated with database 140) over network 110. The image of the vehicle and the attributes of the vehicle may be transmitted to inventory system 150 to be associated with each other for vehicle listing generation and publishing.

Network 110 facilitates communication and sharing of information between mobile device 120, onboarding system 130, and inventory system 150. Network 110 may be any type of network that provides communications, exchanges information, and/or facilitates the exchange of information. For example, network 110 may be the Internet, a Local Area Network, a cellular network, a public switched telephone network (“PSTN”), or other suitable connection(s) that enables transmission of information between the components of system 100. Network 110 may support a variety of electronic messaging formats and may further support a variety of services and applications for mobile devices 120.

Additionally or alternatively, network 110 may include a direct communication network. Direct communications may use any suitable technologies, including, for example, BLUETOOTH™, BLUETOOTH LE™ (BLE), Wi-Fi, near field communications (NFC), or other suitable communication methods that provide a medium for transmitting data between separate devices. In some embodiments, mobile device 120 and onboarding system 130 may connect and communicate through a direct communications network.

Mobile device 120 may include a smart phone, a tablet, a smart watch or other wearable computing device, an in-vehicle touch screen display device, and a laptop computer. Mobile device 120 may include video/audio input devices such as a video camera, a web camera, a microphone or the like. Mobile device 120 may also include one or more software applications that enable the mobile devices to engage in communications, such as messaging, text messages, email, VoIP, and video conferences, with one another and with onboarding system 130. Mobile device 120 may capture one or more images (e.g., a still image or frames of video data) of a vehicle using a camera component of mobile device 120 or an associated imaging system. In certain embodiments, mobile device 120 may be replaced with a user device such as a PC computer, which may operate substantially in the same manner as embodiments of mobile device 120.

The one or more images of the vehicle can be processed by an identification application of mobile device 120 to determine attributes of the vehicle. Such processing may be performed by mobile device 120 and may occur during or after capture of the one or more images. In some instances, mobile device 120 may transmit the one or more images to onboarding system 130 for identification of attributes. In various instances, identification of attributes can be performed at least in part on mobile device 120 and at least in part on onboarding system 130.

Onboarding system 130 may be configured to create and manage entries for vehicles brought into the dealership and process the entries for onboarding the vehicles to an inventory for display and/or sale. For example, the vehicles can include various vehicles brought in through the trade-in process. In some examples described herein, a trade-in vehicle may be taken as an example to describe implementation of some embodiments. It is appreciated that the embodiments may be similarly applied to other vehicles. Onboarding system 130 may store and manage information about the vehicles, such as collecting and storing various attributes of the vehicles upon initial evaluation by the dealership. Of course, onboarding system 130 may also collect and store the attributes in other instances unrelated to a trade-in process. The attributes may include one or more of VIN, model, make, year, trim level, door count, exterior, color, body style, engine type, condition, mileage, etc. Onboarding system 130 may further store and manage processing information about the vehicles, such as dates the vehicles are brought in, historical damage, repairs, pricing, etc. For example, when a trade-in vehicle is brought in, a dealership staff member can input one or more attributes and processing information of the vehicle into onboarding system 130 and create an entry for the vehicle. Onboarding system 130 may be associated with a database 140, which can be used to store some or all of the above data.

Onboarding system 130 may include one or more computing devices, such as a plurality of communicatively linked servers, workstations, desktop computers, or special-purpose computing devices, consistent with disclosed embodiments. Onboarding system 130 may be standalone, or it may be part of a subsystem, which may be part of a larger system. Onboarding system 130 may comprise one or more applications and/or services. The one or more computing devices can be configured to execute these applications and/or services to perform the functions described herein. For example, onboarding system 130 can be hosted on a cloud computing platform, such as AMAZON WEB SERVICES, SOFTLAYER, and MICROSOFT CLOUD. As an additional example, onboarding system 130 can be hosted on a workstation to perform the functions described herein.

In some instances, data associated with the vehicle entries stored in onboarding system 130 is shared with mobile device 120 and/or inventory system 150. For example, mobile device 120 may query onboarding system 130 for a vehicle entry that matches a vehicle depicted in a vehicle image. Mobile device 120 may determine attributes of the vehicle based on the vehicle image. Based on the determined attributes, onboarding system 130 can search for a vehicle entry corresponding to a matching vehicle. Onboarding system 130 can then send the matching vehicle entry, or an indication of a matching vehicle entry, to mobile device 120.

For example, mobile device 120 may capture an image of a vehicle and determine the attributes of a depicted vehicle to be “2019 Tesla Model X” with an exterior color of “Blue.” Based on the determined attributes, “2019 Tesla Model X Blue,” onboarding system 130 may perform a search using the attributes as search filters and identify a matching entry. The identified entry of the matching vehicle, or an identifier indicating a matching vehicle, may then be returned to mobile device 120 via, for example, network 110. In some instances, onboarding system 130 may identify two or more vehicles matching “2019 Tesla Model X Blue.” Other attributes of the two or more vehicle may be different, for example, the vehicles may have different trim level, or may have different optional features. The identified two or more vehicles, or an identifier of multiple matches, can then be sent to mobile device 120 and displayed to the user for verification and selection.

In addition, onboarding system 130 may further search and identify one or more vehicles similar to attributes determined by mobile device 120. Continuing with the foregoing example, onboarding system 130 can search and identify vehicles that are similar to “2019 Tesla Model X Blue.” Similar vehicles, as used herein, can include vehicles matching a pre-set number/percentage of attributes as those determined by mobile device 120. For example, vehicles similar to “2019 Tesla Model X Blue” may include vehicles matching “2019 Tesla Model X Black” or “2018 Tesla Model S Red.” The similar vehicles and the associated entry data can also be sent to mobile device 120, and can be displayed to the user.

In some embodiments, onboarding system 130 shares some or all vehicle entry data with inventory system 150, which can use the entry data, such as vehicle attributes, to generate vehicle listings. For example, onboarding system 130 may be linked to inventory system 150 for data transmission and/or exchange. Based on user operations or automatically, onboarding system 130 may transmit vehicle attributes to inventory system 150 via network 110. Inventory system 150 can associate the vehicle attributes with images received from mobile device 120, for generating a vehicle listing. Alternatively, onboarding system 130 and inventory system 150 may share access to the same database or databases (such as database 140), where data stored in onboarding system 130 can be accessed or pulled by inventory system 150.

In some embodiments, onboarding system 130 may include or be associated with a machine learning module that can be used to identify vehicle attributes based on vehicle images captured by mobile device 120. Mobile device 120 can transmit the captured images to onboarding system 130 for vehicle attributes identification. The machine learning module may include trained machine learning models, such as convolutional neural networks, to identify attributes of the vehicle, such as one or more of VIN, make, model, model year, trim level, color, body style, door count, condition, etc. The machine learning models can be trained using training data including a variety of vehicle and non-vehicle images captured under a variety of conditions and from a variety of angles. Based on the trained models, the machine learning module may identify attributes of the vehicle based on vehicle images or processed image data. After the attributes are identified, onboarding system 130 may transmit the determined attributes to mobile device 120 for further processing.

Database 140 may include one or more physical or virtual databases coupled with onboarding system 130. Database 140 may include one or more computing devices configured with appropriate software to perform database operations on behalf of onboarding system 130 and/or inventory system 150. For example, database 140 may store entry data associated with vehicles to be onboarded, such as vehicle images, vehicle features, and information regarding vehicle sales like costs or pricing. Database 140 may include relational databases (e.g., Oracle™ databases, Sybase™ databases, or the like) or non-relational databases (e.g., Hadoop™ sequence files, HBase™, Cassandra™ or the like). The particular implementation of database 140 is not intended to be limiting. In some embodiments, database 140 may be associated with onboarding system 130 (e.g., operated or controlled by the same entity as onboarding system 130). In various embodiments, database 140 may be associated with inventory system 150 (e.g., database 140 may be linked to or otherwise communicate with inventory system 150 for data transmission).

As noted above, database 140 can store vehicle entries. These vehicle entries may correspond to vehicles to be onboarded to an inventory associated with a dealership. For example, the vehicle entries can include entries corresponding to various trade-in vehicles brought into the dealership. The entries can include some or all the vehicle information included in onboarding system 130, such as one or more of VIN, model, make, year, trim level, color, body style, door count, engine type, vehicle images (if any), etc. For used vehicles, the entries may further include the mileage information, vehicle condition, and pricing information. In some embodiments, the entries stored in database 140 may include additional information, compared to the vehicle information contained in onboarding system 130. For example, the entries stored in database 140 may further include information about whether and when the entries have been requested and shared with mobile device 120 and/or inventory system 150, whether a corresponding vehicle listing has been generated or published, an address of or a link to the corresponding vehicle listing, current onboarding status of the vehicle such as reconditioning or repair status, and approximate date when the vehicle is ready for sale.

Database 140 may include computing components (e.g., database management system, database server, etc.) configured to receive and process requests for data stored in database 140 and provide such stored data in response to the requests. For example, based on images and/or vehicle attributes received from mobile device 120, a database management system associated with database 140 may search for a corresponding entry matching the vehicle depicted in the images and stored in database 140. Further, while database 140 is shown separately, in some embodiments database 140 may be included in or otherwise related to one or more of mobile device 120, onboarding system 130, and inventory system 150.

Inventory system 150 may include one or more computing devices, such as a plurality of communicatively linked servers, workstations, desktop computers, or special-purpose computing devices, consistent with disclosed embodiments. Inventory system 150 may be standalone, or it may be part of a subsystem, which may be part of a larger system. Inventory system 150 may be configured to obtain and record vehicles onboarded into the inventory of a dealership and ready for display or sale. For example, inventory system 150 may associate vehicle images received from mobile device 120 with vehicle attributes received from onboarding system 130. In some embodiments, inventory system 150 may include or be associated with a third-party API for generating vehicle listings corresponding to the vehicles in inventory. The generated vehicle listings may be published on an associated website or another online platform or a downloadable application. For example, inventory system 150 can be operated by, associated with, and/or controlled by the same dealership operating onboarding system 130. After the vehicles are onboarded into the inventory, inventory system 150 may generate listings corresponding to the vehicles and present the listings on the dealership's web site.

As would be appreciated by one of ordinary skill in the art, the particular division of functions depicted in FIG. 1 is not intended to be limiting. In some embodiments, one system can be configured to perform the functions of one or more components of system 100. For example, onboarding system 130 and inventory system 150 may share a combined system having one or more processors. The combined system can perform the functionalities of one or more of onboarding system 130 and inventory system 150 as described above. In some embodiments, multiple systems can be configured to perform the functions of a component of system 100. For example, multiple systems can perform the functions of onboarding system 130. In this example, a first system may receive vehicle images and/or vehicle attributes from mobile device 120, a second system may query database 140 for an entry matching the vehicle depicted in the image, and a third system may transmit vehicle attributes to inventory system 150 for associating the images with the vehicle attributes. Additional rearrangements and distributions of functionality would be apparent to one of skill in the art.

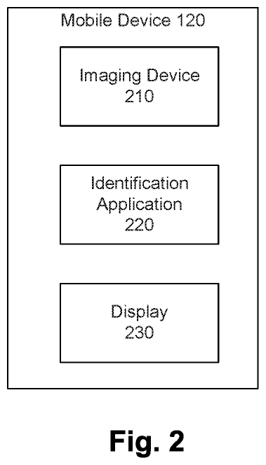

FIG. 2 depicts a block diagram of an exemplary mobile device 120, consistent with disclosed embodiments. As shown in FIG. 2, mobile device 120 may include an imaging device 210, an identification application 220, and a display 230. It is appreciated that mobile device 120 may include additional or fewer components than those depicted in FIG. 2, the configuration of which is not limited by the presently disclosed embodiments. Imaging device 210 can capture a vehicle image, which can be displayed on display 230 and processed by identification application 220. The image can further be transmitted by mobile device 120 to another system (such as onboarding system 130).

Imaging device 210 may be configured to capture one or more images, consistent with disclosed embodiments. Imaging device can be a camera or video camera (e.g., a smartphone or laptop camera, or the like). In some embodiments, imaging device 210 can include charged coupled device (CCD) sensors, or complementary metal-oxide-semiconductor (CMOS) image sensors for their reduced power consumption attributes. Imaging device 210 may be configured to process captured images to reduce distortion or correct optical aberrations. Imaging device 210 can further be configured to convert the image into a format suitable for transmission, storage, or display. Additionally or alternatively, mobile device 120 can be configured to provide the captured images to another system for processing (e.g., onboarding system 130), via network 110. Imaging acquisition parameters can be adjusted through settings of imaging device 210. For example, exposure and focus can be adjusted; and different modes such as HDR (high dynamic range), Burst Mode, or flash mode can be applied based on the actual setting.

Identification application 220 may be an application program installed in memory of mobile device 120 and executed by one or more processors of mobile device 120, which may be used to identify attributes of a vehicle based on an image (which may include a frame of a video feed). Non-limiting examples of suitable identification applications are described in U.S. Pat. No. 10,319,007, and incorporated herein by reference. The vehicle image may be processed to obtain feature data of the image, which can be compared with a database of known vehicle attributes. In some embodiments, identification application 220 can use trained machine learning models, such as convolutional neural networks, to identify attributes of the vehicle based on the processed image data, such as one or more of VIN, make, model, model year, trim level, color, body style, door count, and condition. The machine learning models can be trained using training data including a variety of vehicle and non-vehicle images captured under a variety of conditions and from a variety of angles. Based on the trained models, identification application 220 can identify attributes of the vehicle based on the image captured by imaging device 210. For example, identification application 220 can use a pre-trained model to identify model and make of the vehicle depicted in the image. Other attributes can also similarly be identified, such as year, color, trim, door count, body style, condition, etc. In some instances, the machine learning models implemented in identification application 220 may be the same as or different from those implemented in onboarding system 130.

In some embodiments, identification application 220 may be configured to determine a quality of captured images, consistent with disclosed embodiments. High-quality images may be those suitable for use in identifying a vehicle, while low quality images may be unsuitable for use in identifying a vehicle. Examples of low-quality images include images that do not capture the entirety of the vehicle, images that are too dark or out of focus, and images in which the vehicle is obstructed. In response to determining that a captured image is low-quality, identification application 220 may prompt the user to retake the image. Identification application 220 can further provide the user instructions based on the quality of captured image. For example, if the captured image lacks sufficient brightness, identification application 220 may provide a prompt message on display 230, “please increase brightness.” As another example, if the contrast of the image is not sufficient, identification application 220 may provide a prompt message on display 230, “please adjust contrast.” These examples are not intended to be limiting: other prompts can be provided to address other quality issues in the captured images. In some embodiments, the prompt can be presented via a visual alert (e.g., an augmented reality image displayed on display 230, such as a text message or reticle), audio alert, a haptic alert (e.g., a vibration), or any combination of the foregoing. Once the image acquisition setting is adjusted and an image suitable for the identification is obtained, identification application 220 can identify attributes of the vehicle depicted in the image. In some embodiments, imaging device 210 can capture multiple images (e.g., a sequence of images or a video feed that include multiple frames). Identification application 220 can perform the identification process based on some or all of the captured multiple images.

Identification application 220 can be configured to select some of the captured multiple images for sending to inventory system 150 to be associated with corresponding vehicle attributes, consistent with disclosed embodiments. For example, when the multiple images comprise a video feed, the selected images can be frames taken out of the video feed. For example, identification application 220 can be configured to determine a quality score for the images based one or more image quality parameters. The image quality parameters can include, for example, focus, contrast, obstructions, brightness, blurriness, distortions, color accuracy, etc. Identification application 220 can determine the quality score based on criteria corresponding to each quality parameter. For example, a contribution of a quality parameter to the score can depend on whether a value of the quality parameter exceeds a threshold (e.g., an image satisfies a brightness threshold, a degree of focus threshold, an obstruction detection threshold, etc.). In some embodiments, the thresholds may be preset and each threshold may correspond to each quality parameter. For example, a score can be determined for each quality parameter based on a corresponding preset threshold. A total score can be determined as an overall quality score. Images with higher scores can be selected for providing to inventory system 150. For example, images with a quality score higher than a preset threshold can be selected, or a predetermined number of images with higher quality can be selected.

Identification application 220 can be configured to generate a display including the attributes information. In some embodiments, this display can superimpose the attributes information on the vehicle image. As a non-limiting example, identification application 220 may identify the attributes “Blue,” “Tesla,” and “Model X” as corresponding to one or more captured vehicle images. These attributes can be displayed to the user superimposed on an image of the vehicle (e.g., one of the captured images used to identify the attributes or simply the present image captured by imaging device 210).

Display 230 may be configured to present various information to the user on a screen. Display 230 can take the form of, for example, a liquid crystal display (LCD) display, an organic light-emitting diode (OLED) display, and a touch screen. Display 230 can further serve as an input device by interacting with a user and responding to the user's touch or contact. In some embodiments, when imaging device 210 captures an image or a video of a vehicle, the image or video can simultaneously be presented on display 230. The user can view the image or video on the display and can further adjust the image acquisition parameters accordingly.

In some instances, display 230 can be used to display a matching vehicle and associated data received from onboarding system 130. For example, onboarding system 130 may conduct a search for a matching vehicle based on vehicle attributes determined by mobile device 120. Onboarding system 130 may return the identified matching vehicle to mobile device 120, including the vehicle attributes recorded in the corresponding vehicle entry. The matching vehicle and the associated vehicle attributes received from onboarding system 130 can be displayed on display 230. A user may provide input confirming whether the matching vehicle is the same as the vehicle depicted in the vehicle image captured by imaging device 210.

It is appreciated that the structure and components of mobile device 120 depicted in FIG. 2 is only exemplary. Mobile device 120 may include fewer components or additional components. The described functions of mobile device 120 can be allocated among the components of mobile device 120 as described, or differently. For example, mobile device 120 may include a communication component which can receive and transmit information and facilitate information exchange between mobile device 120 and other devices or systems, such as onboarding system 130. As an additional example, the communication component can be configured to send the vehicle image captured by imaging device 210 and the vehicle attributes determined by identification application 220 to onboarding system 130 and/or inventory system 150 for further processing.

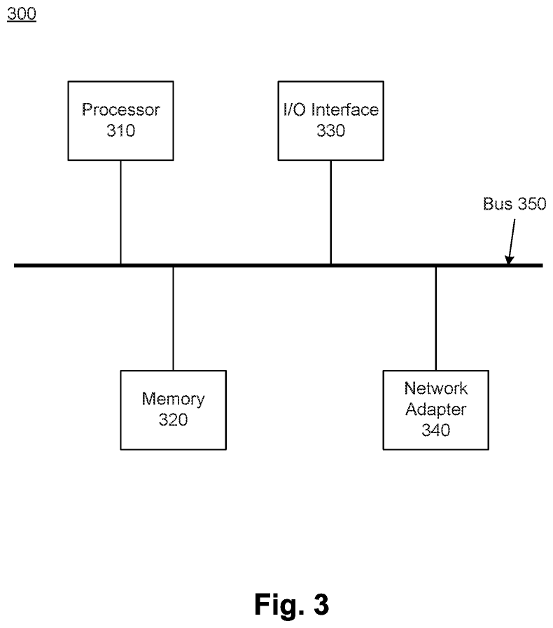

FIG. 3 depicts a block diagram of an exemplary computing device 300 suitable for use with the disclosed embodiments. According to some embodiments, computing device 300 includes a processor 310, memory 320, I/O interface(s) 330, and network adapter 340. These units may communicate with each other via bus 350, or wirelessly. The components shown in FIG. 3 may reside in a single device or multiple devices. Mobile device 120, onboarding system 130 and/or inventory system 150 can comprise computing devices similar to computing device 300.

In various embodiments, processor 310 may be one or more microprocessors or central processor units performing various methods in accordance to the embodiment. Memory 320 may include one or more computer hard disks, random access memory, removable storage, or remote computer storage. In various embodiments, memory 320 stores various software programs executed by processor 310. I/O interfaces 330 may include a keyboard, a mouse, an audio input device, a touch screen, or an infrared input interface. Network adapter 340 enables computing device 300 to exchange information with external networks, such as network 110 as depicted in FIG. 1. In various embodiments, network adapter 340 may include a wireless wide area network adapter, or a local area network adapter.

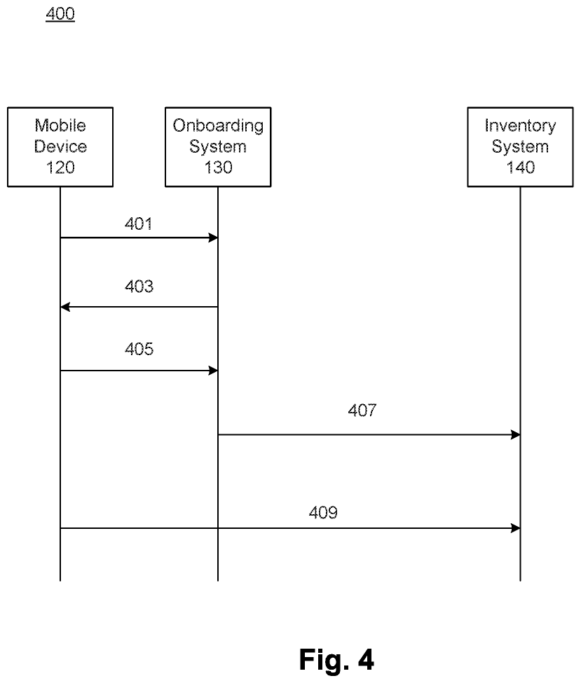

FIG. 4 depicts an exemplary interaction diagram of method 400 for identifying and onboarding a vehicle into an inventory, consistent with disclosed embodiments. As shown in FIG. 4, the process may involve interaction steps 401-409 between various components of system 100. These interactions may enable inventory system 150 to receive images of a vehicle via mobile device 120, as a user interacts with mobile device 120 to capture vehicle images and/or obtains attributes of the vehicle. Inventory system 150 may further obtain vehicle entry data (including vehicle attributes) from onboarding system 130. In this manner, method 400 enables inventory system 150 to obtain and associate vehicle images with corresponding vehicle attributes for onboarding a vehicle into the inventory.

In step 401, mobile device 120 may send a vehicle image and/or vehicle attributes determined based on the vehicle image to onboarding system 130. Mobile device 120 may be associated with or operated by a staff member of an auto dealership. Onboarding system 130 may be an internal system of the dealership and may store a plurality of vehicle entries corresponding to vehicles at the dealership that have been loaded onto onboarding system 130 as part of an initial evaluation, and that are to be onboarded into the dealership's inventory. In an exemplary embodiment, the vehicles may include trade-in vehicles brought in by previous vehicle owners. During the trade-in process, onboarding system 130 may create vehicle entries and record information of the vehicles, such as various attributes of the vehicle.

Mobile device 120 may capture, through an associated imaging component (such as imaging device 210), an image of a vehicle that is yet to be onboarded. The image may further be a frame of a video feed. For example, after the vehicle is entered into onboarding system 130 and before the vehicle is processed and added into the inventory, a staff member may capture an image of the vehicle, which can later be included in a corresponding vehicle listing. Mobile device 120 may further, via a vehicle identification application (such as identification application 220), determine attributes of the vehicle depicted in the captured image.

Mobile device 120 may send the determined attributes to onboarding system 130, along with a query request for a matching vehicle. In some embodiments, mobile device 120 may determine attributes of the vehicle in a captured image to be “2018 Tesla Model X Blue.” Mobile device 120 may send the determined attributes to onboarding system 130, and request onboarding system 130 to search in an associated database for a vehicle entry matching “2018 Tesla Model X Blue.” In other embodiments, mobile device 120 may send the captured images for onboarding system 130 to process and determine the vehicle attributes.

In step 403, onboarding system 130 conducts a search in an associated database (such as database 140) to identity a vehicle matching the vehicle depicted in the image captured by mobile device 120, and return the matching vehicle to mobile device 120. Database 140 may store a plurality of entries of vehicles that have been entered into onboarding system 130 at the dealership. These may include vehicles that have been evaluated but not yet onboarded into inventory. After receiving the query request from mobile device 120, onboarding system 130 may conduct a search, for example, through a database management system of database 140, to locate a vehicle entry matching the attributes and/or image included in the query request. For example, the database management system of database 140 can compare the received vehicle attributes to the attributes included in the plurality of vehicle entries stored therein, and identify one vehicle entry that have matching attributes. In some embodiments, such matching may require the received attributes equal the corresponding attributes of a vehicle entry. In various embodiments, such matching may include soft matching, wherein the received attributes and the corresponding attributes of a vehicle entry satisfy some matching criterion (e.g., a distance-based criterion that transforms differences between the received attributes and the corresponding attributes into a distance and identifies a soft match when the distance is less than a threshold). The disclosed embodiments are not intended to be limited to a particular type of matching.

In some instances, onboarding system 130 may identify two or more vehicle entries that match the received attributes. This may occur when the dealership has two vehicles with similar attributes. For example, the dealership may have two trade-in vehicles that match “2018 Tesla Model X Blue.” The two vehicles may have different trim levels, body styles, or other different attributes. After identifying the vehicle entries matching the received attributes, onboarding system 130 may return the matching vehicle entries to mobile device 120.

In step 405, mobile device 120 can send confirmation to onboarding system 130, confirming that the vehicle indicated in the received matching vehicle entry is the same as the vehicle depicted in the vehicle image. In instances where onboarding system returns two or more vehicle entries to mobile device 120, the confirmation can further reflect a user selection from the two or more vehicle entries. In those cases, mobile device 120 can display the two or more vehicle entries returned by onboarding system 130 to the user, and request user input to select one entry that matches the vehicle depicted in the image. As an example, onboarding system 130 may return two entries, entry A and entry B. Both entry A and entry B match the received attributes “2018 Tesla Model X Blue,” but entry A may indicate a trim level of 100D, entry B may indicate a trim level of 75D. Mobile device 120 may display entry A and entry B to the user, and may receive user selection of entry A. For example, the staff member of the dealership capturing the vehicle image may verify the trim level of vehicle to be 75D, and confirm the matching vehicle should be the vehicle indicated in entry A. Mobile device 120, once receiving user input selecting entry A, may further send confirmation to onboarding system 130 indicating the user selection.

In step 407, after receiving user confirmation that the matching vehicle entry includes the same vehicle as the vehicle depicted in the vehicle image, onboarding system 130 can send vehicle attributes of the matching vehicle to inventory system 150. In some embodiments, onboarding system 130 may send the entire matching vehicle entry to inventory system 150. In some instances, transmission of the vehicle entry or vehicle attributes can further be based on an instruction from mobile device 120. For example, when mobile device 120 sends the user confirmation to onboarding system 130 in step 405, mobile device 120 can send an instruction requesting onboarding system 130 to share or make available vehicle attributes of the matching vehicle to inventory system 150.

In step 409, mobile device 120 can send the vehicle image to inventory system 150 for associating the vehicle image with the attributes of the matching vehicle. Inventory system 150 can associate the vehicle image received from mobile device 120 with attributes of the matching vehicle received from onboarding system 130. In some embodiments, inventory system 150 can utilize the associated vehicle image and the vehicle attributes to generate a corresponding vehicle listing. For example, inventory system 150 can include or be associated with a third-party API, which can create a vehicle listing including the vehicle image and the vehicle attributes. The generated listing can further be published on an associated web platform.

With the technical solutions described above with reference to FIG. 4, after a vehicle is brought into a dealership for onboarding into the inventory, a dealership staff member can use a mobile device to capture an image of the vehicle. The mobile device can, via a vehicle identification application, determine attributes of the vehicle. Based on the determined attributes, an onboarding system can identify a vehicle entry of a matching vehicle. Through an inventory system, the vehicle image and the attributes of the matching vehicle can be associated with each other for vehicle listing creation and publishing. Accordingly, vehicles can be identified and onboarded into the inventory in an efficient manner. Further, the technical solutions can reduce the resources devoted by dealerships for capturing and processing images of vehicles during the onboarding process.

As would be appreciated by one of skill in the art, the particular order and arrangement of steps disclosed in FIG. 4 is not intended to be limiting. For example, steps can be re-arranged or combined without departing from the envisioned embodiments. Steps can be divided into sub-steps that can be performed in a different order, or by other components of system 100. Furthermore, additional steps may be added or steps may be removed without departing from the envisioned embodiments.

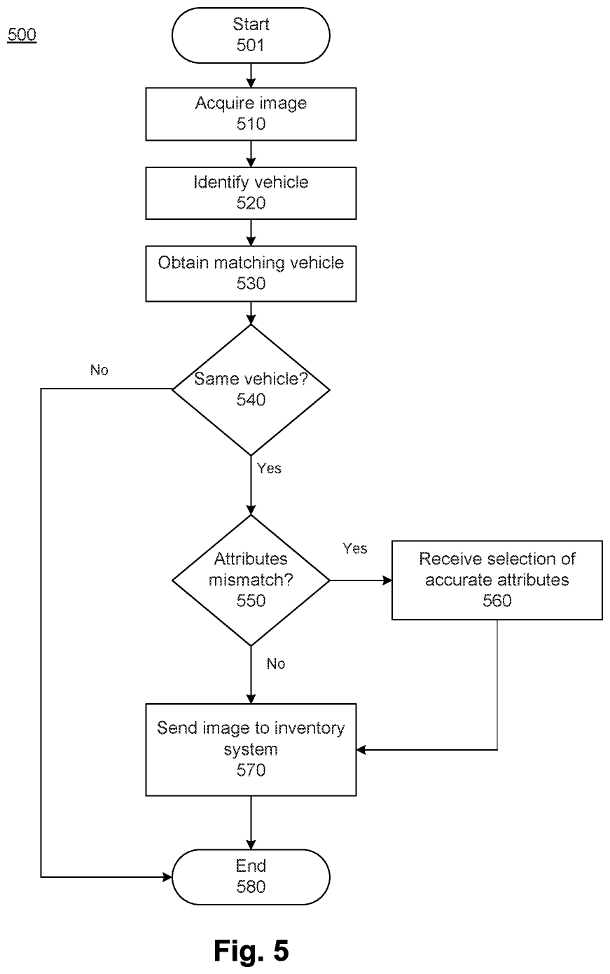

FIG. 5 depicts a flowchart of an exemplary process 500 for identifying and onboarding a vehicle to an inventory, consistent with disclosed embodiments. As shown in FIG. 5, process 500 includes steps 501-580. Process 500 can be implemented by, for example, a mobile device (such as mobile device 120) and a vehicle listing onboarding system (such as onboarding system 130), for identifying and onboarding a vehicle into an inventory.

After starting in step 501, mobile device 120 can acquire one or more images of a vehicle in step 510. For example, after a vehicle is brought into a dealership through the trade-in process, the vehicle may need to go through cleaning and reconditioning before it can be onboarded into the inventory. A user, such as a dealership staff member, can operate mobile device 120 to send a signal to a camera component or camera system (such as imaging device 210) to capture a digital image of the vehicle. The camera component or camera system can be communicatively linked to mobile device 120, such that the captured image can be transmitted to mobile device 120 for further processing. In some embodiments, the captured image can include a frame of a video feed. In some instances, the user may also position the camera component of mobile device 120 in response to instructions provided by identification application 220. In some embodiments, identification application 220 can display identified features and other vehicle related information on top of the vehicle image.

In step 520, mobile device 120 can determine one or more attributes of the vehicle in the image using identification application 220. In some embodiments, mobile device 120 can transmit the vehicle image to another system (such as onboarding system 130, or one or more remote processors) with a request to identify vehicle attributes based on the vehicle image. For example, the determined attributes can be “2018 Tesla Model X Blue.” Mobile device 120 can then send the image and/or the determined attributes to onboarding system 130. In some embodiments, if mobile device 120 captures multiple images, mobile device 120 (for example, through identification application 120) can further perform a quality assessment of the images and select one or more of higher-quality images for sending to onboarding system 130 and/or inventory system 150 for subsequent processing.

In some embodiments, mobile device 120 can further request the user to manually input vehicle attributes. For example, through a graphical user interface (GUI), the user can input/select one or more vehicle attributes. In the foregoing example, the user may, through visual inspection, determine that the vehicle trim is “75D.” The manually input vehicle attributes can then be added to or associated with the attributes determined by identification application 220. As another example, the manual identification by the user may be performed simultaneously or may facilitate each other. Once mobile application 220 determines the vehicle to be a “2018 Tesla Model X Blue,” mobile application 220 may present a plurality of potential attributes for user selection or confirmation. With respect to trim level, mobile device 120 may display a plurality of trim level choices corresponding to “2018 Tesla Model X:” 75D, 100D, and P100D. The user can then input/select based on the displayed choices. The user can further input other attributes not determined by identification application 220. For example, the user can manually add the VIN, vehicle condition, engine type, or other attributes of the depicted vehicle.

In step 530, mobile device 120 obtains a matching vehicle entry from onboarding system 130. In some embodiments, mobile device 120 can send the determined vehicle attributes to onboarding system 130, requesting onboarding system to query an associated database (such as database 140) for a vehicle entry matching the determined attributes. Database 140 can store various data entries corresponding to a plurality of vehicles to be onboarded. The data entries can include one or more vehicle attributes and vehicle processing information, such as information about the associated trade-in process, costs or pricing. In the forgoing example, based on the received attributes “2018 Tesla Model X Blue,” onboarding system 130 can conduct a query in database 140 and identify a vehicle entry matching “2018 Tesla Model X Blue.” Onboarding system 130 can then send the matching vehicle entry to mobile device 120.

In some embodiments, onboarding system 130 may receive the vehicle image from mobile device 120 and can perform vehicle identification verification based on the received image. In some embodiments, when onboarding system 130 receives the vehicle image along with the query request, onboarding system 130 may further perform attributes identification based on the received image. For example, onboarding system 130 can be configured to apply the received image to a machine learning model trained to identify vehicle attributes based on a vehicle image. In some embodiments, this machine learning model may be the same as the machine learning model used by identification application 220. In some embodiments, this machine learning model may be a newer version of the machine learning model used by identification application 220. Alternatively or additionally, the machine learning model can be a more sophisticated and/or computationally intensive machine learning model than the machine learning model used by identification application 220.

For example, a machine learning model implemented in onboarding system 130 can use different machine learning algorithms than those used in identification application 220. As an additional example, this machine learning model can be trained with a different or larger set of training data to obtain more accurate identification results. In some embodiments, for example, the machine learning models implemented in onboarding system 130 can utilize inventory vehicle listings associated with inventory system 150 as training data to improve the performance of the machine learning models. As the vehicle listings corresponding to inventory vehicles are updated/supplemented, the listings can be fed to the machine learning models in onboarding system 130 for model training purposes. On the other hand, identification application 220 can be a plug-in module executing identification functionalities using limited resources available on mobile device 120. The functionalities, identification accuracy, and computational capability of the machine learning models utilized by identification process 220 can be different from, or relatively limited compared to those implemented in onboarding system 130.

The vehicle attributes determined by onboarding system 130 may be different from the attributes received from mobile device 120. For example, the vehicle attributes determined by onboarding system 130 can include more attributes than those received from mobile device 120. For example, onboarding system 130 may determine the depicted vehicle to be “2018 Tesla Model X Blue 75D,” instead of the “2018 Tesla Model X Blue” received from mobile device 120. Onboarding system 130 may further use the newly determined “2018 Tesla Model X Blue 75D” for subsequent processing. In some embodiments, onboarding system 130 may further update the existing vehicle entry with the newly determined vehicle attributes by correcting, supplementing, or replacing one or more attributes. As another example, mobile device 120 may determine a preset group of attributes, such as model, make, year, color, and trim; and onboarding system 130 can determine additional attributes, such as condition.

In some instances, the machine learning models implemented in onboarding system 130 may be trained to analyze a vehicle image and classify condition of the depicted vehicle into one of a plurality of predetermined grades, such as excellent, good, fair, or poor. Other types of grades can be used, which are not limited herein. For example, the machine learning models can be trained using a set of training data including vehicle images taken at different angles and depicting vehicles in one of the predetermined grades. The training data set can include data from various vehicle listing systems, such as various auto trading websites. Various machine learning algorithms can be used, such as linear regression, logistic regression, decision tree, support vector machine (SVM), and convolutional neural networks (CNN).

In some embodiments, the condition classification process can further include identifying visual exterior damage appearing on the depicted vehicle. For example, edge detection and object detection techniques can be implemented to segment the vehicle image into different regions, such as normal regions and regions of interest. The normal regions can include regions in the vehicle image that depict car body background without damage. The regions of interest can include regions which appear abnormal and may include car exterior damage. The identified regions of interest may further be analyzed and classified into damage or normal. In some embodiments, the damage classification can further indicate the degree and type of damage, such as severe scratch, severe dent, minor scratch, or minor dent. The training data set for damage identification can include vehicle images depicting known damage. The condition classification of the vehicle can be based on the number of identified damages and the severity of the damages. Further, the size and location information of the identified damage regions can further be stored in the corresponding vehicle entry for subsequent processing, such as evaluating the vehicle for pricing purposes.

In step 540, mobile device 120 can receive user confirmation whether the received matching vehicle entry from onboarding system 130 relates to the same vehicle as depicted in the vehicle image. For example, after receiving the matching vehicle entry from onboarding system 130, mobile device 120 can display (for example, through display 230) the received vehicle entry to the user, and request user input confirming whether the vehicle entry relates to the same vehicle depicted in the vehicle image. In some embodiments, step 540 may further include receiving user selection of one vehicle entry from a plurality of vehicle entries provided by onboarding system 130.

If in step 540, mobile device 120 receives user confirmation that the received matching vehicle entry relates to the same vehicle as depicted in the vehicle image, process 500 can proceed to step 550. If in step 540, mobile device 120 receives user confirmation that the received matching vehicle entry does not relate to the same vehicle depicted in the vehicle image, process 500 can end. Alternatively, in some embodiments, process 500 may return back to step 510 and request the user capture another vehicle image, or return to step 520 and request identification application 220 to redetermine vehicle attributes based on the captured image.

In some embodiments, after mobile device 120 receives user confirmation that the received matching vehicle entry relates to the same vehicle as depicted in the vehicle image, mobile device 120 can further receive one or more vehicle entries relating to vehicles similar to the one depicted in the vehicle image. For example, based on the user confirmation, onboarding system 130 can query database 140 (or another database storing various vehicle entries or listings) for vehicle entries satisfying a preset similarity threshold to the depicted vehicle. The preset similarity threshold can refer to, for example, vehicle entries matching at least a preset percentage/number of vehicle attributes as the depicted vehicle.

Mobile device 120 can further display the identified similar vehicle entries to the user through display 230, and request user selection of one or more vehicles that are mostly closely related to the depicted vehicle as confirmed by the user. For example, the user can review the identified similar vehicle entries, and select vehicle entries that relate to vehicles of same/similar brands, same/similar conditions, same/similar geographical regions, and/or same/similar price ranges. In this manner, similar vehicle entries can be identified and/or linked to the depicted vehicle for future evaluation purposes. As an example, the similar vehicle entries can provide pricing reference when evaluating the value of the depicted vehicle. Additionally or alternatively, vehicle listings of the similar vehicles can be linked to a listing of the depicted vehicle, so that a user viewing the listing of the depicted vehicle can view or access listings of the similar vehicles.

In step 550, mobile device 120 can determine whether there is a mismatch between the determined attributes and the attributes included in the matching vehicle entry identified by onboarding system 130. For example, the query step in step 530 may be based on a soft matching requiring the differences between the received attributes from mobile device 120 and the matching vehicle entry to be less than a predetermined threshold. Alternatively, step 530 may include determining the differences between the received attributes and each vehicle entry stored in database 140, and identify the vehicle entry with the smallest difference from the received attributes. In those instances, mobile device 120 can present the different attributes to the user, and request the user to select an accurate set of attributes.

As an example, mobile device 120 may determine attributes of a vehicle depicted in the vehicle image to be “2018 Tesla Model S Blue,” onboarding system 130 may identify a matching vehicle entry corresponding to “2017 Tesla Model S Blue,” which may be the entry that is most similar to “2018 Tesla Model S Blue” among the entries stored in database 140. Mobile device 120 may compare the determined attributes with the attributes included in the matching vehicle entry. Based on the comparison, mobile device 120 can determine that there is a mismatch between the attributes determined by mobile device 120 and the attributes included in the matching vehicle entry. Mobile device 120 can then display the difference to the user, and request the user to select an accurate set of attributes.

In step 560, mobile device 120 can receive user input selecting a set of accurate attributes. Based on the differences in attributes displayed by mobile device 120, the user (such as a staff member of the dealership) can input a selection of accurate attributes. In the foregoing example, the staff member of the dealership can inspect the vehicle and verify that the vehicle depicted in the vehicle image is a “2018” model, rather than a “2017” model. The staff member can select the accurate attributes to be “2018 Tesla Model S Blue.” In some embodiments, mobile device 120 can further send the selected accurate attributes to onboarding system 130, along with instructions to update the corresponding vehicle entry. In the forgoing example, mobile device 120 can send the selected accurate attributes “2018 Tesla Model S Blue” to onboarding system 130, and instructing onboarding system 130 to update the corresponding vehicle entry by replacing “2017” with “2018” to reflect that the vehicle is a “2018” model.

In step 570, mobile device 120 can transmit the vehicle image to inventory system 150 to be associated with the corresponding vehicle attributes. Mobile device 120 can further provide instructions to inventory system 150 to generate a vehicle listing based on the transmitted vehicle image and the matching vehicle attributes. In some embodiments, onboarding system 130 can provide the corresponding vehicle attributes or the corresponding vehicle entry to inventory system 150. Inventory system 150 can associate the vehicle image received from mobile device 120 with the corresponding vehicle attributes for vehicle listing generation and publishing purposes. For example, an API associated with inventory system 150 can aggregate the vehicle attributes and vehicle image to create a vehicle listing.

In some embodiments, mobile device 120 can further send instructions to inventory system 150, instructing inventory system 150 to make the created vehicle listing available to a vehicle listing system, such as a listing system associated with a dealership or an auto transaction platform like the CAPITAL ONE® AUTO NAVIGATOR® platform. For example, inventory system 150, via an associated API, can be linked to the vehicle listing system such that the created vehicle listing can be pulled by the vehicle listing system and published on an associated web platform. Alternatively, based on the instructions from mobile device 120, inventory system 150 can push the created vehicle listing to the vehicle listing system for publishing.

To further illustrate the application and benefits of the technical solutions described above, an exemplary application scenario is provided next. A dealership may take in a trade-in vehicle, and a staff member may enter basic information of the trade-in vehicle in an onboarding system and create a vehicle entry. The onboarding system can store entries corresponding to a plurality of trade-in vehicles and other vehicles that are to be onboarded into the inventory. The vehicle entry corresponding to the trade-in vehicle can include various attributes of the vehicle obtained or inputted during the trade-in process. For example, the entry may indicate that vehicle to be a “2018 Tesla Model X Blue.”

Before the trade-in vehicle is added to the inventory, and a vehicle listing is created for publishing on an associated web platform such as the dealership's website, images of the vehicle can be taken so that the images can be included in the vehicle listing. A staff member of the dealership can capture an image of the trade-in vehicle using a mobile device. The mobile device can further include a vehicle identification application, which can determine vehicle attributes based on the vehicle image. In some instances, the mobile device can also send the captured image to a remote system for identifying vehicle attributes. For example, based on the captured image, the identification application can determine the vehicle to be a “2018 Tesla Model X Blue 75D.” Based on the determined attributes, mobile device can send a query request to the onboarding system, requesting a matching vehicle entry. The onboarding system can query an associated database storing various vehicle entries and identify an entry that matches “2018 Tesla Model X Blue 75D.”

The onboarding system may identify the entry indicating “2018 Tesla Model X Blue” as the matching entry. For example, the onboarding system of the dealership may only have one trade-in vehicle that matches “2018 Tesla Model X Blue,” which is mostly similar to “2018 Tesla Model X Blue 75D.” The onboarding system can return the matching vehicle entry “2018 Tesla Model X Blue” to the mobile device. The mobile device can display the matching vehicle entry on a display to the user, and request the user confirm whether the matching vehicle entry is the same as the vehicle depicted in the captured image. After receiving user confirmation, the mobile device can send the captured vehicle image to an inventory system associated with the dealership, and instruct the inventory system to associate the vehicle image with the corresponding vehicle attributes. The mobile device can further send the determined vehicle attributes to the inventory system or the onboarding system. The onboarding system can update the vehicle entry based on the determined attributes, and/or further provide the matching vehicle entry to the inventory system.

Based on the received vehicle image and the corresponding vehicle attributes, the inventory system can generate a vehicle listing including the vehicle image and the corresponding vehicle attributes and publish the vehicle listing on an associated web platform. Accordingly, the vehicle can be onboarded into the inventory and a corresponding listing can be created. In this manner, the users can benefit from a vehicle listing that includes an actual image of the vehicle. The dealership can efficiently onboard the vehicles into inventory, without the need to devote a significant amount of time and resources for capturing vehicle images and matching each image to a corresponding vehicle.

As would be appreciated by one of skill in the art, the particular order and arrangement of steps disclosed in FIG. 5 is not intended to be limiting. For example, steps can be re-arranged or combined without departing from the envisioned embodiments. Steps can be divided into sub-steps that can be performed in a different order, or by other components of system 100. Furthermore, additional steps may be added or steps may be removed without departing from the envisioned embodiments.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

1. A system of identifying and onboarding an inventory item, comprising:
a mobile device having at least one processor; and
at least one non-transitory computer-readable medium storing instructions that, when executed, cause the at least one processor to perform operations, comprising:
capturing an image of a vehicle;
determining, based on the captured image, attributes of the imaged vehicle;
querying, over a network, a vehicle onboarding system storing a plurality of vehicle attributes, the query being based on the imaged vehicle;
receiving a matching vehicle from the vehicle onboarding system based on the query;
displaying the matching vehicle received from the vehicle onboarding system via a display of the mobile device;
requesting input from a user of the mobile device to confirm the matching vehicle is the same vehicle as the imaged vehicle based on the display;
receiving confirmation that the imaged vehicle is the same as the matched vehicle; and
transmitting the image of the vehicle to a vehicle inventory system configured to maintain an inventory of onboarded vehicles, wherein transmitting the image comprises transmitting instructions to associate the image with the vehicle attributes of the matching vehicle in the inventory.

2-3. (canceled)

4. The system of claim 1, wherein the determined attributes further comprise at least one of a vehicle identification number (VIN), a make and model, a model year, a trim level, an exterior color, a body style, or a door count of the imaged vehicle.

5. The system of claim 1, further comprising:
determining a mismatch between the determined attributes of the imaged vehicle and the matching vehicle received from the vehicle onboarding system; and
requesting input from a user of the mobile device to select an accurate set of vehicle attributes based on the mismatch.

6. The system of claim 5, further comprising transmitting the accurate set of vehicle attributes to the vehicle onboarding system with instructions to replace the vehicle attributes associated with the matching vehicle on the vehicle onboarding system.

7. The system of claim 1, wherein determining the attributes of the imaged vehicle further comprises transmitting the captured image to one or more remote processors with a request to identify the attributes based on the captured image.

8. The system of claim 1, wherein determining the attributes of the imaged vehicle further comprises processing data from the captured image via the at least one processor of the mobile device and determining the attributes by comparing the processed data to a database of known vehicle attributes.

9. The system of claim 1, further comprising requesting input from a user of the mobile device to manually input one or more user-identified attributes of the imaged vehicle and associating the user-identified attributes with the determined attributes of the imaged vehicle.

10. The system of claim 1, further comprising transmitting, based on receiving the matching vehicle, a request to the vehicle onboarding system to transfer or link the vehicle attributes of the matching vehicle to the vehicle inventory system.

11. The system of claim 1, wherein the transmitted instructions to the vehicle inventory system further comprise instructions to generate a vehicle listing based on the vehicle attributes of the matching vehicle and the transmitted image.

12. The system of claim 11, wherein the transmitted instructions to generate the vehicle listing further comprise instructions to make available, via an application programming interface (API) of the vehicle inventory system, the vehicle attributes of the matching vehicle and the transmitted image of the vehicle to a vehicle listing system.

13. The system of claim 1, wherein capturing of the image of the vehicle further comprises sending a signal to a camera of the mobile device to capture a digital image.

14. The system of claim 1, wherein capturing of the image of the vehicle further comprises receiving the captured image from a camera or camera system communicatively linked to the mobile device.

15. The system of claim 1, wherein the vehicle inventory system and vehicle onboarding system comprise a combined system having one or more processors.

16. The system of claim 1, wherein the vehicle inventory system and vehicle onboarding system comprise a plurality of communicatively linked servers.

17. The system of claim 1, further comprising determining a vehicle exterior condition based on the captured image of the vehicle.

18. The system of claim 17, wherein determining the vehicle exterior condition comprises evaluating the vehicle in one of a plurality of predetermined grades.

19. The system of claim 17, wherein determining the vehicle exterior condition comprises identifying instances of visual damage appearing on the captured image.

20. The system of claim 17, wherein determining the vehicle condition comprises transmitting the captured image to one or more remote processors with a request to determine, based on machine learning and image analysis, the vehicle condition.

21. A method for identifying and onboarding an inventory item, comprising:
capturing, by a mobile device, an image of a vehicle;
determining, based on the captured image, attributes of the imaged vehicle;
querying, over a network, a vehicle onboarding system storing a plurality of vehicle attributes, the query being based on the imaged vehicle;
receiving a matching vehicle from the vehicle onboarding system based on the query;
transmitting the image of the vehicle to a vehicle inventory system configured to maintain an inventory of onboarded vehicles, wherein transmitting the image comprises transmitting instructions to supplement existing images in a listing of the matching vehicle in the inventory with the image.
